(19) United States
(12) Patent Application Publication
(10) Pub. No.: US 2022/0288916 A1
(43) Pub. Date: Sep. 15, 2022

(54) Method for Processing a Lithographic Printing Plate

(71) Applicant: AGFA OFFSET BE, Mortsel (BE)

(72) Inventors: Philippe Moriame, Mortsel (BE); Inge Claes, Mortsel (BE)

(73) Assignee: AGFA OFFSET BE, Mortsel (BE)

(21) Appl. No.: 17/634,306

(22) PCT Filed: Aug. 10, 2020
(86) PCT No.: PCT/EP2020/072383

§ 371 Date: Feb. 10, 2022

(30) Foreign Application Priority Data
Aug. 13, 2019 (EP) 19191421.7

(51) Int. Cl. B41C 1/10

(52) U.S. Cl. CPC B41C 1/1016; B41C 2210/02; B41C 2210/06; B41C 2210/14; B41C 2210/24; B41C 2210/262; B41C 2210/266

(57) ABSTRACT

A method for processing a heat-sensitive positive-working lithographic printing plate material is disclosed which comprises at least two layers: —a first layer comprising an oleophilic resin and/or a vinyl acetal (co)polymer; —a second layer comprising a (co)polymer which is located between the support and the first layer; comprising the steps of: —treating the plate material with an alkaline development solution, —treating the plate material with a first gum solution and consecutively with a second gum solution which are configured as a cascade whereby the second gum solution overflows into the first gum solution; and which gum solutions include a buffer; characterized in that the pH of the first gum solution reaches a steady state value above the pKa value of the (co)polymer present in the second layer.

### TECHNICAL FIELD

The present invention relates to a method for processing lithographic printing plates with a reduced consumption of processing liquids.

### BACKGROUND ART

Lithographic printing typically involves the use of a so-called printing master such as a printing plate which is mounted on a cylinder of a rotary printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. These areas can also be referred to as printing and non-printing areas respectively or as image and non-image areas respectively. In so-called driographic printing, the lithographic image consists of ink-accepting and ink-adhesive (ink-repelling) areas and during driographic printing, only ink is supplied to the master.

Lithographic printing masters are generally obtained by the image-wise exposure and processing of a printing plate precursor (referred to hereafter as “plate material” or briefly as “plate”), which contains a heat- or light-sensitive coating on a substrate. The coating of the plate material is exposed image-wise to heat or light, typically by means of a digitally modulated exposure device such as a laser, which triggers a (physico-)chemical process, such as ablation, polymerization, insolubilization by cross-linking of a polymer or by particle coagulation of a thermoplastic polymer latex, solubilization by the destruction of intermolecular interactions or by increasing the penetrability of a development barrier layer. Although some plate materials are capable of producing a lithographic image immediately after exposure, the most popular plate materials require wet processing with a developer since the exposure produces a difference of solubility or of rate of dissolution in a developer between the exposed and the non-exposed areas of the coating. In positive working plate materials, the exposed areas of the coating dissolve in the developer while the non-exposed areas remain resistant to the developer. In negative working plate materials, the non-exposed areas of the coating dissolve in the developer while the exposed areas remain resistant to the developer. Most plate materials contain a hydrophobic coating on a hydrophilic substrate, so that the areas which remain resistant to the developer define the ink-accepting, printing areas of the plate while the hydrophilic substrate is revealed by the dissolution of the coating in the developer at the non-printing areas.

Conventionally, a plate material is developed by immersing it in, or spraying it with a developer as it passes through the processing apparatus. Typically, the material is also subjected to mechanical rubbing with e.g. one or more rotating brushes or specified roller(s)—after a while or after being treated with the developer. After development, the plate is typically rinsed with water to remove any remaining developer and then gummed, which is sometimes also called finished or desensitized. Gumming involves the protection of the coating on the lithographic image, especially the non-printing areas, to avoid contamination or oxidation of the aluminum substrate. Gum solution can be applied by immersion, by spraying or by jetting as disclosed for example in EP 1 524 113.

Non-image areas which are dissolved in the developer during processing—possibly together with other components of the developer—often precipitate or salt-out (i.e. organic sludge) in the processing, rinsing and/or gumming baths, deposit on exit rollers and/or build-up on heater elements. As a result, not only the maintenance of the processing system becomes more burdensome, but the efficiency of processing, washing and/or gumming may be significantly reduced. In addition, such deposits may also adhere on the printing plate which impairs the images formed thereon; e.g. accept ink in the non-image areas. Insufficient sedimentation stability of the processing liquids—such as alkaline developers, rinse and/or gum solutions—leading to depositions is especially observed during long run processing—i.e. processing with the same developing solution for a longer period before a restart which typically involves draining the exhausted developer, cleaning the apparatus and refilling the apparatus with fresh developer.

In the art, in order to solve these contamination problems during processing, often the alkaline developer, the rinse and/or gum solutions used during processing are abundantly replenished. However, this leads to large consumption of development solutions and is, from an ecological point of view, unfavourable. Indeed, an important trend in lithographic platemaking is related to ecology and sustainability. Systems and methods which enable low consumption of processing liquids such as developer, rinse water and/or gum solution, or which allow processing with aqueous developers comprising no hazardous chemicals and/or which have a pH close to 7 (neutral developer), have attracted a lot of attention in the marketplace. It remains therefore a challenge to provide sustainable processing systems which consume low amounts of processing liquids but which provide at the same time high quality printing plates.

### SUMMARY OF INVENTION

It is an object of the present invention to provide a method for processing positive-working lithographic printing plate materials which enables to reduce the amount of waste liquids generated during processing and gumming. More specific, it is an object to provide a processing method whereby the formation of (in)organic sludge, precipitate and/or deposit materials in the gum solution is minimized or even avoided.

These object(s) are realised by the method of processing defined in claim 1, i.e. a method for processing a heat-sensitive positive-working lithographic printing plate material which comprises on a support having a hydrophilic surface or which is provided with a hydrophilic layer, a heat and/or light-sensitive coating which comprises at least two layers:
a first layer comprising an oleophilic resin and/or a vinyl acetal (co)polymer;
a second layer comprising a (co)polymer which is located between the support and the first layer;
comprising the steps of:
   treating the plate material with an alkaline development solution,
   treating the plate material with a first gum solution and consecutively with a second gum solution, which gum solutions include a buffer and which are configured as a cascade whereby the second gum solution overflows into the first gum solution,
      characterized in that the pH of the first gum solution reaches a steady state pH above the pKa value of the (co)polymer in the second layer,

The pKa of the (co)polymer is defined as the pKa of the monomeric units which are present in the (co)polymer and, in case of different pKa values, the pKa of the (co)polymer is defined as the lowest pKa value. More precisely, the functional groups present on the monomeric units present in the (co)polymer generate a pKa or various pKa values.

The current invention has the specific feature that, although the first and second gum solutions originate from the same gum solution, the pH of the first gum solution increases during processing to a substantially constant value above the pKa value of the (co)polymer present in the second layer of the coating, while the pH of the second gum solution does not significantly change; in other words, the first gum solution exceeds above the buffer capacity of the buffer present in the gum solution while the seconds gum solution remains within the buffer capacity.

It was surprisingly found that the solubility and/or the stability of components dragged-out form the alkaline developer solution into the first gum solution as well as possibly remaining non-image areas which dissolve into the first gum solution, is significantly improved. With an improved solubility and/or stability is meant that the tendency to form precipitate (i.e. (in)organic sludge) and/or deposit materials is reduced; with precipitate and/or deposit materials is meant any insoluble material that either can be removed by filtration or which cannot be filtered off. As a result, a reduced amount of gum liquid is consumed and thus less waste liquid is generated. In addition, possible adherence of deposit and/or precipitate or salted-out materials on the printing plate material which impairs the images formed thereon—e.g. accept ink in the non-image areas—is avoided.

Printing plate material is herein also referred to as printing plate precursor.

Other features, elements, steps, characteristics and advantages of the present invention will become more apparent from the following detailed description of preferred embodiments of the present invention. Specific embodiments of the invention are also defined in the dependent claims.

### BRIEF DESCRIPTION OF THE DRAWINGS

FIG. 1 shows a simulation of the cross-contamination in the first gumming unit.

FIG. 2 shows a simulation of the cross-contamination in the second gumming unit.

### DESCRIPTION OF EMBODIMENTS

### Development

According to the current invention, an (exposed) printing plate material is developed by means of a suitable alkaline developer, also referred to herein as “development solution” or “development liquid”. In the development step, the non-printing areas of the coating of the plate material are at least partially removed without substantially removing the printing areas. In the event the non-printing areas are not completely removed by the development, complete removal may be achieved by the treatment with the gum solution.

Development of a plate material is typically performed in a vessel containing development solution, for example by dipping or immersing the plate in the developer, or by (spin-)coating, spraying and/or pouring developer onto the plate. Such a vessel is referred to as a development unit or a development cavity. A development cavity is an essentially closed volume defined by a bottom plate, a cover plate and sidewalls and has an entry aperture where the plate enters the cavity and an exit aperture where the plate leaves the cavity. The treatment with development solution may be combined with mechanical rubbing, e.g. by one, two or more rotating brushes and/or specified rollers e.g. Molton rollers. Preferably, the plate is not brushed during the treatment with alkaline development solution. During the development step, any water-soluble protective layer on top of the image-recording layer, if present, is preferably also removed.

During processing, the development solution becomes loaded with components of the coating that have been removed by the development and the amount of material in the development solution increases as more plates are developed. Due to this increasing amount of material in the development solution, the activity of the development solution typically decreases which may result in a reduced ability to remove the non-printing areas of the lithographic image and/or a reduced ability to maintain the removed components in solution or in a dispersed state. In addition, the pH of the development solution may decrease due to the dissolution of carbon dioxide from the air into the development solution as the time passes. Therefore, the development solution is preferably shielded from the air by a cover plate. In a preferred embodiment, a low amount (as defined below) of development solution is used during a period of about one week or more, more preferably about two weeks or more, during which a plurality of plates is processed with the same development solution, either with or without regeneration. After that period, the development unit is reloaded with fresh development solution. This process is preferably fully automatic, which means that the development solution is drained from the development unit and that the development unit is refilled with fresh developer by means of a system including a supply tank including fresh development solution, a waste tank for collecting the exhausted developer and the necessary pipes and pumps. The fresh development solution may be produced automatically inside the processing apparatus by diluting a more concentrated solution with water.

Because the development solution is used during just a limited period of time, only a negligible amount of sludge—such as salted-out compounds, precipitated or flocculated ingredients and/or other undissolved compounds—may be formed during the processing period between two (re)starts. Also, the level of dissolved ingredients and/or compounds present in the developing solution may be limited; i.e. the development solution is not exhausted. As a result, not only the maintenance of the development unit or cavity becomes less burdensome, but also deposit on the exit and/or other rollers, and/or build-up on heater elements in the developer unit is limited as well as possible adherence of sludge on the printing plate which may impair the images formed thereon; e.g. accept ink in the non-image areas.

### Regeneration of Development Solution

The activity level of the development solution may be maintained during its working period by adding replenishment solution. Depending on the concentration of the mentioned regenerator liquids, the rate of regeneration may be between 1 ml and 100 ml per m² of treated plate material, preferably between 2 ml/m² and 85 ml/m², 4 ml/m² and 60 ml/m², more preferably between 5 ml/m² and 30 ml/m².

It has been found that by using small amounts of developer for a limited period in time, little replenishment is required to keep the activity of the developer at a sufficient level and/or constant. Therefore, the embodiment wherein a small volume of developer is used generates, compared to development of the prior art where large amounts of developer for a longer period in time are used, less waste. Indeed, the waste—including the amount of drained developer and the amount of applied replenisher—generated during said limited period in time, is less compared to the waste that would have been generated when the development would have been carried out during a longer period in time.

In addition, the volume of development solution is preferably kept constant by for example adding water and/or development solution; also referred to in the art as top-up the development solution.

The mentioned regenerator liquids can be added continuously, after a predetermined period of time, and/or in batches when the activity of the development solution becomes too low and/or to keep the activity level constant. The activity level of the development solution can be determined by monitoring e.g. pH, density, viscosity, conductivity, the number and/or area (square meters) of processed plates processed since a (re)start with fresh solution and/or the time lapse since a (re)start with fresh solution. When the addition of regenerator is regulated by measurement of one of these parameters, for example the conductivity of the development solution, the regenerator liquid can be added when a predetermined threshold value of that parameter is reached or is crossed. The amount of regenerator added each time depends on the predetermined threshold value. For example, when the measured parameter is the number of square meters of plate material processed, a predetermined amount of replenishment is added each time after processing a predetermined area of plate material. As a further example, the measured parameter can be the conductivity or conductivity decrease of the solution monitored with a conductivity meter. Below a defined conductivity value, regenerator can automatically be added to the development solution.

The development unit or cavity preferably contains an overflow pipe which drains the development solution into a collector tank. The drained development solution may be purified and/or regenerated by e.g. filtration, decantation or centrifugation and then reused, however, the drained development solution is preferably collected for disposal.

### Recirculation of Development Solution

The development solution present in the development unit or cavity can be circulated, e.g. by means of a circulation pump. In its most simple form, circulation means that a flow of development solution is generated within the development unit or cavity, preferably producing sufficient turbulence to enhance the removal of non-printing areas from the coating of the plate. As a result, during the treatment with the development solution, application of one or more brush(es) during the processing step is not required. In a preferred embodiment, no brushes are used in the processing step. The development solution may be sucked in via an outlet of the development unit or cavity, preferably near the exit rollers of the development unit, from where it may be drained to a waste collector tank.

According to a more preferred embodiment, at least a part of the development solution is not drained but recirculated, i.e. conveyed along a closed loop, e.g. from a sump of the development unit or cavity into one or more inlet openings such as for example spray or jet nozzles (as described further below), which apply the developer onto the plate and/or onto an optional brush which is in contact with the plate. Excess of developer then flows from the plate back into the sump. The most preferred embodiment of such recirculation involves pumping the developer into the development unit or cavity.

During recirculation, the development solution is preferably at least partly removed (sucked) from the development unit and then injected through at least one inlet opening formed in for example the sidewall of the development unit or cavity back into the development unit or cavity, thereby circulating and stirring the development solution. More preferably, the development solution which is sucked away is injected through at least one inlet opening in the development unit or cavity near the exit roller pair.

Even more preferably, the development solution which is sucked away is injected through at least one inlet opening formed in the cover plate of the development unit and/or cavity. Most preferably, the development solution which is sucked away is injected through at least one spray bar which is preferably positioned in the development unit near the exit roller pair, more preferably parallel to the exit rollers. The development solution is preferably at least partly sucked in from the area under and/or near the exit rollers in the development unit or cavity. Preferably, a filter is present in the circulation system, e.g. in the pipes, which is capable of removing sludge and/or dissolved ingredients from the development solution.

### Development Solution

Any type of alkaline developer may be used in the method of the present invention, depending on the type of printing plate that is processed. Solvent-based or aqueous alkaline developers may be used. Solvent based developers have mainly been used to develop negative-working plate materials, while positive-working plate materials typically require a highly alkaline developer without much solvent therein.

Unless otherwise indicated, the amounts of developer ingredients given herein refer to the fresh developer as used for a (re)start. Such fresh developer may be obtained as a ready-to-use solution or by diluting a more concentrated solution that is supplied by the manufacturer with water, e.g. a dilution between 2 and 10 times. The dilution of a developer concentrate may be done in a separate apparatus or may be integrated in the processing apparatus. As a result, the preferred embodiments of this invention allow to develop plates with good clean-out by using less than 150 ml/m2 of such concentrated solution, preferably less than 50 ml/m2, and most preferably less than 20 ml/m2 of such concentrated solution. 0.5 to 10 ml/m2. Alternatively, 0.2 to 2 ml/m² of developer is preferably used.

A preferred alkaline developer is an aqueous solution which has a pH of at least 10, more typically at least 12, preferably from 13 to 14. Preferred high pH developers comprise at least one alkali metal silicate, such as lithium silicate, sodium silicate, and/or potassium silicate. Sodium silicate and potassium silicate are preferred, and sodium silicate is most preferred. A mixture of alkali metal silicates may be used if desired. Especially preferred high pH developers comprise an alkali metal silicate having a SiO2 to M2O weight ratio of at least of at least 0.3, in which M is the alkali metal. Preferably, the ratio is from 0.3 to 1.2. More preferably, it is from 0.6 to 1.1, and most preferably, it is from 0.7 to 1.0. The amount of alkali metal silicate in the high pH developer is typically at least 20 g of SiO2 per 1000 g of developer (that is, at least 2 wt. %) and preferably from 20 g to 80 g of SiO2 per 1000 g of developer (2-8 wt. %). More preferably, it is 40 g to 65 g of SiO2 per 1000 g of developer (4-6.5 wt. %).

In a highly preferred embodiment, as an alternative for the alkali metal silicate, alkalinity is provided by a suitable concentration of any suitable base. Such developers are referred to as “silicate-free” developers. Suitable bases include ammonium hydroxide, sodium hydroxide, lithium hydroxide, potassium hydroxide and/or organic amines, and/or mixtures thereof. A preferred base is sodium hydroxide. Such silicate-free developers do substantially exclude silicates; they are substantially silicate-free developers. The word “substantially” means that the presence of unavoidable impurities, minute silicates as byproduct and/or very small amounts which might have been added to the development solution, are tolerated. Very small amounts refer to for example less than 1% wt, preferably less than 0.5% wt and most preferably less than 0.1% wt, based on the total weight of the development solution.

Solvent-based alkaline developers preferably have a pH above 9, more preferably above 9.5, and most preferably above 10. Solvent-based developers comprise water and an organic solvent or a mixture of organic solvents. They are typically free of silicates (silicate-free see above), alkali metal hydroxides, and mixtures of silicates and alkali metal hydroxides. The developer is preferably a single phase. Consequently, the organic solvent or mixture of organic solvents is preferably either miscible with water or sufficiently soluble in the developer so that phase separation does not occur.

The following organic solvents and mixtures thereof are suitable for use in solvent-based developers: the reaction products of phenol with ethylene oxide (phenol ethoxylates) and with propylene oxide (phenol propoxylates), such as ethylene glycol phenyl ether (phenoxyethanol); benzyl alcohol; esters of ethylene glycol and of propylene glycol with acids having six or fewer carbon atoms, and ethers of ethylene glycol, diethylene glycol, and propylene glycol with alkyl groups having six or fewer carbon atoms, such as 2-ethoxyethanol, 2-(2-ethoxy)ethoxyethanol, and 2-butoxyethanol. A developer that comprises phenoxyethanol is preferred. The developer typically comprises 0.5 wt % to 15 wt %, preferably 3 wt % to 5 wt % of the organic solvent or solvents, based on the weight of the developer.

A suitable alternative developer for processing positive plates comprises a non-reducing sugar and a base. Such alkaline developers preferably have a pH above 9, more preferably above 10, and most preferably above 12. Such developers are typically free of silicates (silicate-free see above), alkali metal hydroxides, and mixtures of silicates and alkali metal hydroxides. The term “non-reducing sugar” means a saccharide which is free of free aldehyde or ketone group and thus is not reducing, e.g. trehalose type oligosaccharides, glycosides and sugar alcohols obtained by hydrogenating and reducing saccharides. Examples of the trehalose type oligosaccharides include saccharose, and trehalose. Examples of the glycosides include alkyl glycoside, phenol glycoside, and mustard oil glycoside. Examples of the sugar alcohols include D, L-arabitol, ribitol, xylitol, D,L-sorbitol, D,L-mannitol, D,L-iditol, D,L-talitol, dulcitol, and arodulicitol. Further, maltitol obtained by the hydrogenation of disaccharide or reduced material (reduced starch sirup) obtained by the hydrogenation of oligosaccharide may be used. Preferred among these non-reducing sugars are sugar alcohols and saccharose. Even more desirable among these non-reducing sugars are D-sorbitol, saccharose, and reduced starch sirup because they have buffer action within a proper pH range.

These non-reducing sugars may be used alone or in combination of two or more thereof. The proportion of these non-reducing sugars in the developer is preferably from 0.1 to 30% by weight, more preferably from 1 to 25% by weight.

The aforementioned non-reducing sugar may be used in combination with an alkaline agent as a base, properly selected from the group consisting of known materials such as inorganic alkaline agents, e.g. sodium hydroxide, potassium hydroxide, lithium hydroxide, trisodium phosphate, tripotassium phosphate, triammonium phosphate, disodium phosphate, dipotassium phosphate, diammonium phosphate, sodium carbonate, potassium carbonate, ammonium carbonate, sodium hydrogencarbonate, potassium hydrogencarbonate, ammonium hydrogencarbonate, sodium borate, potassium borate and ammonium borate, potassium citrate, tripotassium citrate, and sodium citrate.

Further preferred examples of alkaline agents include organic alkaline agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine and pyridine.

These alkaline agents may be used singly or in combination of two or more thereof. Preferred among these alkaline agents are sodium hydroxide, potassium hydroxide, trisodium phosphate, tripotassium phosphate, sodium carbonate and potassium carbonate.

Another alternative silicate-free and sugar-free alkaline aqueous developer composition has a pH of at least 12 and comprises (a) a hydroxide, (b) a metal cation M2′ selected from barium, calcium, strontium, and zinc cations, (c) a chelating agent for the metal cation M+ and (d) an alkali metal salt different than all of a, b, and c above.

Optional components of all the above mentioned developers are e.g. anionic, nonionic and/or amphoteric surfactants, biocides (antimicrobial and/or antifungal agents), antifoaming agents or chelating agents (such as alkali gluconates), solubilizers, image protecting agents such as blockers or retardants, dissolution inhibitors and thickening agents (water soluble or water dispersible polyhydroxy compounds such as glycerin or polyethylene glycol).

### Gumming

According to the present invention, the development described above is followed by at least two treatments with a gum solution, which is applied by means of a cascading gumming section comprising a first and a second gumming unit wherein a first and second gumming step are carried out respectively. This gumming section is also referred to as the “gumming system”.

The two gumming steps are carried out in two different gumming units configured as a cascade whereby the gum solution present in the second gumming unit overflows into the first gumming unit. Such a cascade configuration provides the advantage that sludge formation and/or contamination by for example carry-over of dissolved ingredients in the second gum solution is reduced, whereby an increase of the viscosity of the gum solution in the second gumming unit can be reduced or inhibited. This results in an improved lifetime of the gumming system as only the gum solution of the first gumming unit becomes loaded with contaminants from the dragged-out development solution, whereby the second gum solution can be used for gumming a higher number of plates so as to save costs and to enable a sustainable system. The gum solution present in the first gumming unit is also referred to herein as “the first gum solution”, and the gum solution in the second gumming unit is also referred to herein as “the second gum solution”.

In the first gumming step, the processed plate is treated with a first gum solution. The main purpose of this treatment is to rinse and/or neutralise the plate, i.e. the removal of any developer from the surface of the plate, and to ensure good clean-out of the image, if not already obtained in the development unit. In the second gumming step, the plate material is subsequently treated with a second gum solution. The main purpose of the second step is to protect the lithographic image by the application of a gum layer as further discussed below. It shall be understood, however, that the said purpose of the first and second gumming steps is not a limitation of the present invention. For instance, also the second gum solution may contribute to the clean-out of the image, for those plate materials of which the non-printing areas of the coating are not completely removed after the first gumming step. Reduced clean-out usually results in toning (ink-acceptance in the non-image areas) of the printing plate and/or in ink build-up on the blanket.

The gum solutions are preferably brought into contact with the printing plate by spraying, jetting, immersing, dipping or by a coating technique, including spin coating, roll coating, slot coating or gravure coating. The use of spray bars is preferred. A spray bar typically includes a hollow rod with a predetermined series of holes. The gumming unit(s) may also be provided with at least one roller for rubbing and/or brushing the plate while applying the gum to the coating.

The gum solutions contain, besides the gum components described below, a buffer which allows the pH of the first gum solution to increase to a value greater than the pKa value of the (co)polymer present in the second layer and then remains substantially stable during further processing of the plates, this value is also referred to as the steady state pH or the steady state value. As a result, the functional groups present on the monomeric units of the (co)polymer which have a pKa value below the pH of the steady state pH of the first gum solution, become deprotonated and dissolve and/or disperse in the gum solution. Therefore, the first gum solution has an improved bath life as sludge formation due to dragged-out components originating from the alkaline development solution is highly reduced. The steady state pH of the first gum solution is preferably below the pH of the alkaline developer solution. The steady state pH in the first gum solution is obtained by the combination of the presence of a buffer with preferably a limited buffer capacity, the regulation of the flow-over from the alkaline developer into the first gum solution, the regulation of the flow-over from the first gum solution into the second gum solution, optional addition of water and/replenisher to compensate for possible evaporation, the inflow due to the cascade from the second gum solution and the draining of the first gum solution to waste. Also, the volume of the gum solutions may influence the steady state value. In order to steer the steady state pH in the first gum solution, it is up to the person skilled in the art to fine tune the above described variables.

When an apparatus is used which operates with a relatively small volume of gum solution, for example a volume below 20 l, a steady state pH may already be obtained after processing for example 400 m² of precursor. When an apparatus is used which operates with a higher volume of gum solution, for example a volume between 20 and 100 l, a steady state pH may be obtained after processing for example 1000 m² of precursor

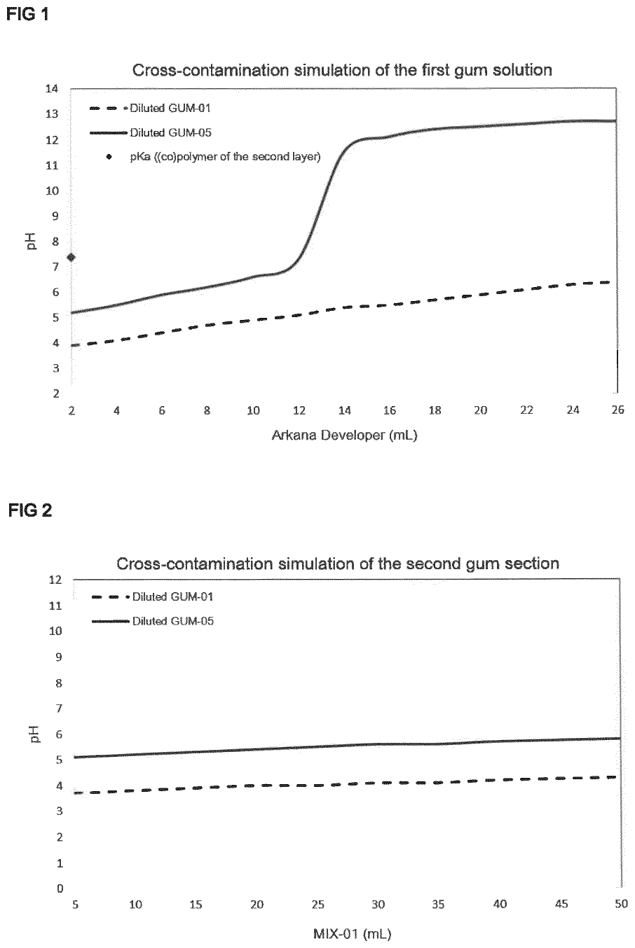

The effect of adding an acid or base to a buffer on the change in pH depends on both the initial pH and the capacity of the buffer to resist pH change. As long as the buffer has not completely reacted, the pH will not change drastically, however once the buffer is depleted, the buffer becomes less resistant to change in pH. By for example selecting a low concentration of HA/A⁻ or by modifying this ratio, the capacity of the buffer can be reduced. A titration curve visually demonstrates buffer capacity. The buffer zone or buffer region is the part of the curve which is substantially flat because addition of base or acid does not affect the pH of the solution drastically. The buffer region reflects the buffer capacity. However, once the curve extends out of the buffer region, it will increase more substantially when a small amount of acid or base is added to the buffer system. In the current invention, it was surprisingly found that by adding a buffer with a limited buffer capacity, the pH in the first gum solution increases due to the dragged-out alkalinity—e.g hydroxide ions—from the alkaline developer solution and reaches a steady state value (see above) which may prevent solidification of sludge. In the second gum solution, the inflow of alkalinity is limited and the buffer capacity is sufficient to keep the pH at a nearly constant value, i.e. without the drift of pH which occurs in the first gum solution. This is illustrated by FIGS. 1 and 2. In FIG. 1, cross-contamination of the first gumming unit due to overflow from the alkaline developer is simulated by titration of the gum solution in the first gumming unit with base (Arkana developer, commercially available from Agfa NV). Gum-01 has a relatively high buffer capacity and as a result, its pH does not increase above the pKa value of the (co)polymer when base (Arkana developer, commercially available from Agfa NV) is added (FIG. 1, dashed line); while Gum-05 has a limited buffer capacity whereby its pH increases above the pKa value of the (co)polymer (FIG. 1, solid line). In FIG. 2, cross-contamination of the second gumming unit due to overflow from the first gumming unit including a limited amount of base (Arkana developer, commercially available from Agfa NV), is simulated by titration of the second gum solution with a mixture including gum from the first gumming unit and a base (Arkana developer, commercially available from Agfa NV) mixture (MIX-01). During the titration, Gum-05 maintains a similar pH stability (FIG. 2, solid line) as Gum-01 (FIG. 2, dashed line).

The buffer preferably maintains the pH of the second gum solution substantially constant. The buffer preferably maintains the pH of the second gum solution to a value between 0.5 and 7; more preferably to a value between 0.5 and 6.

In the current invention, preferably buffers which cover the pH range 0.5 to 9, more preferably 2.6 to 6, are of interest.

A buffer is typically an aqueous solution including a mixture of a weak acid and its conjugate base, or vice versa. Its pH changes very little when a small amount of strong acid or base is added to it. Buffer solutions are capable to keep the pH at a nearly constant value; in other words they regulate the pH. Buffer solutions achieve their resistance to pH change because of the presence of an equilibrium between the acid HA and its conjugate base A⁻:

HA [symbol] H++A−

When some strong acid is added to such an equilibrium mixture of weak acid and its conjugate base, the equilibrium is shifted to the left, in accordance with Le Châtelier's principle. Because of this, the hydrogen ion concentration increases by less than the amount expected for the quantity of strong acid added. Similarly, if strong alkali is added to the mixture the hydrogen ion concentration decreases by less than the amount expected for the quantity of alkali added.

The pH changes relatively slowly in the buffer region which is generally defined as pH=pKₐ of the buffer±about 1. The hydrogen ion concentration decreases by less than the amount expected because most of the added hydroxide ion is consumed in the reaction:

OH−+HA→H2O+A−

and only a little is consumed in the neutralization reaction which results in an increase in pH:

OH−+H+→H2O

Once the acid is more than 95% deprotonated the pH rises rapidly because then most of the added alkali is consumed in the neutralization reaction.

Examples of buffers are mixtures containing acids such as acetic acid, citric acid, oxalic acid, tartaric acid, benzoic acid, molybdic acid, boric acid, nitric acid, sulfuric acid, diethyl barbituric acid, formic acid, lactic acid, ascorbic acid, propionic acid, gluconic acid, lauric acid, carbonic acid, phosphoric acid and/or polyphosphoric acid, and their water soluble metal salts, preferably alkali metal salts; and ammonium salts. Specific examples thereof are ammonium acetate, sodium acetate, potassium acetate, trisodium citrate, tripotassium citrate, sodium oxalate, potassium oxalate, sodium tartrate, potassium tartrate, sodium benzoate, potassium benzoate, sodium molybdate, potassium molybdate, sodium borate, ammonium borate, lithium nitrate, sodium nitrate, potassium nitrate, sodium sulfate, potassium sulfate, sodium diethylbarbiturate, sodium formate, potassium formate, sodium lactate, potassium lactate, sodium ascorbate, potassium ascorbate, sodium propionate, potassium propionate, sodium gluconate, potassium gluconate, sodium laurate, potassium laurate, sodium bicarbonate, potassium bicarbonate, monosodium phosphate, sodium secondary phosphate, sodium tertiary phosphate, monopotassium phosphate, potassium secondary phosphate, potassium tertiary phosphate, ammonium tertiary phosphate, and sodium polyphosphate. Preferred buffers are mixtures containing acetic acid, citric acid, oxalic acid, tartaric acid, sulfuric acid, gluconic acid, carbonic acid, phosphoric acid and/or polyphosphoric acid, and their water soluble metal salts, preferably alkali metal salts; and ammonium salts. Most preferred buffers are mixtures containing acetic acid, citric acid, gluconic acid, carbonic acid, phosphoric acid and/or polyphosphoric acid, and their water soluble metal salts, preferably alkali metal salts. The most preferred buffers are mixtures containing citric acid, gluconic acid and/or phosphoric acid, and their water soluble metal salts, preferably alkali metal salts, and ammonium salts.

Examples of buffers are mixtures containing at least one acid, having a pKa, between 1 and 7, and their water soluble metal salts, preferably alkali metal salts; and ammonium salts. The pKa referring to the first deprotonation of the acid. Preferred buffers are mixtures containing at least one acid, having a pKa between 2 and 6, and their preferably water soluble metal salts, preferably alkali metal salts. Most preferred buffers are mixtures containing at least one acid, having a pKa between 3 and 5, and their preferably water soluble metal salts, preferably alkali metal salts.

More information with regards to buffers which may suitably be used in the current invention are described in CRC Handbook of Chemistry and Physics, 67 th Edition, 1986-1987, Buffer Solutions, Operational Definitions of pH by R. A. Robinson D-144 to D-146.

### (Re)Circulation of Gum Solution

The first and/or second gum solutions are preferably (re)circulated, more preferably independently from one another. The first and second gum solutions are kept in respectively two baths or sumps from which they are recirculated into for example spray bars which supply the gum solution. The gum solutions then flow back into the respective baths or sumps.

Preferably, a filter is present in the (re)circulation system, e.g. in the pipes, which is capable of removing any kind of sludge and/or dissolved ingredients from the gum solutions.

### Regeneration of Gum Solution

The gum solutions may be regenerated by adding water, a replenishment solution or optionally diluted fresh gum solution, or a mixture thereof. Adding optionally diluted fresh gum solution is preferred.

A concentrated replenishment solution can be added as replenishment solution when the concentration of active products is under a desired level in the gum solution. A diluted replenishment solution or water can be used when the concentration of active products is above a desired level in the gum solution and/or when the viscosity of the gum solution is increased or when the volume of the gum solution is under a desired level, e.g. due to evaporation of the solvent or water.

The above mentioned regenerator liquids may be added to the first and/or second gum solution. The amount of regenerator added to the second gum solution may be restricted so as to compensate only for the volume which is drained in the cascade and dragged-out with the plates. The amount of regenerator added to the first gum solution is preferably adjusted to compensate for the degradation of the gum solution by the dragged-out developer and for the volume which is drained as waste.

It is preferred that the amount of replenishment and/or gum solution added for the regeneration of gum solution, is small in order to limit the amount of waste produced during processing. Therefore, the rate of regeneration—depending on the concentration of the replenishment/gum solution—is preferably between 1 ml and 100 ml per m² of treated plates, more preferably between 2 ml/m² and 85 ml/m², more preferably between 4 ml/m² and 60 ml/m² and most preferably between 5 ml/m² and 30 ml/m².

The addition of regenerator, i.e. the type and the amount thereof, may be regulated by the measurement of for example the number and/or area of processed plates, the pH or pH change of the gum solution, the viscosity, the density, the time lapsed since the gumming system was loaded with fresh gum solution, or by monitoring the minimum and maximum volume in each gumming unit, or a combination of at least two of them.

The first gumming unit preferably contains an overflow pipe which drains the gum solution into a collector tank. The drained gum solution may be cleaned by e.g. filtration, decantation or centrifugation and then reused to regenerate the first and/or the second gum solution. Preferably however, the drained first gum solution is collected for disposal.

### Gum Solution

A gum solution is typically an aqueous liquid which comprises one or more surface protective compounds that are capable of protecting the lithographic image of a printing plate against contamination or damaging. Suitable examples of such compounds are film-forming hydrophilic polymers or surfactants. The layer that (in contrast with treatment with the buffered rinse solution where no layer is formed) preferably remains on the plate after treatment with the gum solution in the gumming step and drying preferably comprises between 0.05 and 20 g/m² of the surface protective compound; more preferably 0.1 to 15 g/m². This layer preferably remains on the plate until the plate is mounted on the press and is removed by the ink and/or fountain when the press run has been started. The plate precursor can, if required, be further post-treated with a suitable correcting agent or preservative as known in the art.

The solution of a buffer as described in detail above is added to control the desired pH value or a desired pH range.

The composition of the gum solution described hereafter refers to the fresh gum solution that is used for a (re)start. Preferably, the same gum solution is used for the (re)start in both units of the gumming section. In alternative embodiments, a (re)start may involve filling the first and second gumming unit with different gum solutions, e.g. different concentrations obtained by a different dilution of the same gum solution. In that case, the composition of the gum solution described herein refers to the fresh gum solution used in the second gumming unit. Such fresh gum solution may be obtained as a ready-to-use solution or by diluting a more concentrated solution that is supplied by the manufacturer. The dilution of a gum concentrate may be done in a separate apparatus or may be integrated in the processing apparatus.

Preferably, the second gum solution is reloaded after one week of processing and/or after processing for example 400 m² of precursor. Preferably, the reloading of the first and/or second gum solutions are automated.

Alternatively, the gum quality may be kept constant for a longer period, so that a restart can be postponed for a longer time, for example more than one month, preferably more than two months, more preferably more than four months and most preferably more than six months. According to the present invention, it was found that the gum quality can be kept constant for a substantially longer period due to the use of the buffered rinse solution compared to rinse solutions of the prior art.

Suitable gum solutions, to be used as fresh gum solution in the present invention, are aqueous liquids which comprise one or more surface protective compounds that are capable of protecting the lithographic image of a printing plate against contamination, oxidation or damaging. Suitable examples of such compounds are film-forming hydrophilic polymers or surfactants. In the current invention, a gum solution including film forming-hydrophilic polymers is preferred. The layer that remains on the plate after treatment with the gum solution in the second gumming step and drying preferably comprises between 0.1 and 20 g/m² of the surface protective compound. This layer typically remains on the plate until the plate is mounted on the press and is removed by the ink and/or fountain when the press run has been started. The gum solutions preferably have a (initial) pH below 11, more preferably below 9. In the current invention, the gum solution preferably has a pH between 0.5 and 6. Suitable gum solutions used herein have a pH around 2, 4 or 5

A solution of a non-ionic surfactant can further be added.

### Lithographic Printing Plate Materials

The lithographic printing plate precursor used in the present invention is positive-working, i.e. after exposure and development the exposed areas of the coating are removed from the support and define hydrophilic (non-printing) areas, whereas the non-exposed coating is not removed from the support and defines oleophilic (printing) areas. The hydrophilic areas are defined by the support which has a hydrophilic surface or is provided with a hydrophilic layer. The hydrophobic areas are defined by the coating. Areas having hydrophilic properties means areas having a higher affinity for an aqueous solution than for an oleophilic ink; areas having hydrophobic properties means areas having a higher affinity for an oleophilic ink than for an aqueous solution.

### Support

The preferred support of the lithographic printing plate material used in the present invention has a hydrophilic surface or is provided with a hydrophilic layer. A particularly preferred lithographic support is a grained and anodized aluminum support, more preferably aluminum grained by electrochemical graining in a solution comprising nitric acid and/or hydrochloric acid and then electrochemically anodized in a solution comprising phosphoric acid and/or sulphuric acid.

More features of suitable supports, such as the preferred Ra (roughness) values of the grained surface, the anodic weight (g/m2 of Al2O3 formed by the anodisation), and suitable post-anodic treatments are described in EP 1 356 926. A preferred post-anodic treatment includes treating the support with an aqueous solution comprising a silicate compound.

### Coating Compositions

The imaging mechanism of the heat-sensitive printing plate precursors can be triggered by direct exposure to heat, e.g. by means of a thermal head, or by the light absorption of one or more compounds in the coating that are capable of converting light, more preferably infrared light, into heat. These heat-sensitive lithographic printing plate precursors are preferably not sensitive to visible light, i.e. no substantial effect on the dissolution rate of the coating in the developer is induced by exposure to visible light. Most preferably, the coating is not sensitive to ambient daylight.

A preferred thermal printing plate precursor is positive-working and includes a coating which is based on heat-induced solubilization of an oleophilic resin. The oleophilic resin is preferably a polymer that is soluble in an aqueous developer, more preferably an aqueous alkaline development solution with a pH between 7.5 and 14. Preferred polymers are phenolic resins e.g. novolac, resoles, polyvinyl phenols and carboxy substituted polymers. Typical examples of these polymers are described in DE-A-4007428, DE-A-4027301 and DE-A-4445820. The coating preferably contains at least one layer which includes the phenolic resin(s). This layer is also referred to as “the imaging layer” or the first layer. The amount of phenolic resin present in the coating is preferably at least 50% by weight, preferably at least 80% by weight relative to the total weight of all the components present in the imaging layer.

In a preferred embodiment, the oleophilic resin is a phenolic resin wherein the phenyl group or the hydroxy group is chemically modified with an organic substituent. The phenolic resins which are chemically modified with an organic substituent may exhibit an increased chemical resistance against printing chemicals such as fountain solutions or plate treating liquids such as plate cleaners. Examples of such chemically modified phenolic resins are described in EP-A 0 934 822, EP-A 1 072 432, U.S. Pat. No. 5,641,608, EP-A 0 982 123, WO 99/01795, EP-A 02 102 446, EP-A 02 102 444, EP-A 02 102 445, EP-A 02 102 443, EP-A 03 102 522. The modified resins described in EP-A 02 102 446, are preferred, especially those resins wherein the phenyl-group of said phenolic resin is substituted with a group having the structure —N═N-Q, wherein the —N═N— group is covalently bound to a carbon atom of the phenyl group and wherein Q is an aromatic group.

The oleophilic resin may also be mixed with or replaced by other polymers such as polymers including a urethane group and/or poly(vinyl acetal) resins. Suitable poly(vinyl acetal) resins which are added in order to improve the abrasion resistance of the coating are described in U.S. Pat. Nos. 5,262,270; 5,169,897; 5,534,381; 6,458,511; 6,541,181; 6,087,066; 6,270,938; WO 2001/9682; EP 1 162 209; U.S. Pat. Nos. 6,596,460; 6,596,460; 6,458,503; 6,783,913; 6,818,378; 6,596,456; WO 2002/73315; WO 2002/96961; U.S. Pat. No. 6,818,378; WO 2003/79113; WO 2004/20484; WO 2004/81662; EP 1 627 732; WO 2007/17162; WO 2008/103258; U.S. Pat. Nos. 6,087,066; 6,255,033; WO 2009/5582; WO 2009/85093; WO 2001/09682; US 2009/4599; WO 2009/99518; US 2006/130689; US 2003/166750; U.S. Pat. No. 5,330,877; US 2004/81662; US 2005/3296; EP 1 627 732; WO 2007/3030; US 2009/0291387; US 2010/47723 and US 2011/0059399.

The poly(vinyl acetal) resin preferably contains the following acetal moiety:

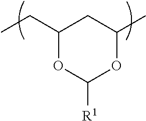

wherein R1 represents an aliphatic carbon chain such as a methyl, ethyl, propyl, butyl or pentyl group, an optionally substituted aryl group such as a phenyl, benzyl, naphthyl, tolyl, ortho- meta- or para-xylyl, anthracenyl or phenanthrenyl, or an optionally substituted heteroaryl group such as a pyridyl, pyrimidyl, pyrazoyl, triazinyl, imidazolyl, furyl, thienyl, isoxazolyl, thiazolyl and carbazoyl group. Most preferably the vinyl acetale is selected from vinyl formal, vinyl ethyral, vinyl propyral and/or vinyl butyral.

Preferred poly(vinyl acetal) resins are copolymers comprising acetal moieties and ethylenic moieties as described in WO2014/106554, WO2015/158566, WO2015/173231, WO2015/189092 and WO2016/001023. Especially preferred poly(vinyl acetale) resins are resins including ethylenic moieties and acetal moieties including an optionally substituted aromatic or heteroaromatic group including at least one hydroxyl group (WO2014/106554), or poly(vinyl acetale) resins including an optionally substituted aromatic or heteroaromatic group are resins including at least one hydroxyl group in ortho or para position relative to an electron withdrawing group (WO2015/158566).

The coating further comprises a second layer that comprises one or more binder(s), also referred to as (co)polymer(s), which is preferably insoluble in water and soluble in an alkaline solution. To minimize sludge in the first gum solution, the binder used in the present invention preferably contains a monomeric unit including at least one functional group which is able to be deprotonated in the first gum solution. As a result, the binder and/or compounds derived from the binder which may be present in the first gum solution due to for example drag over from the alkaline developer, dissolve in the first gum solution. To achieve this solubility, the pKa value of the binder is preferably below the steady state pH of the first gum solution.

The second layer is located between the layer described above comprising the oleophilic resin i.e. the imaging layer, and the hydrophilic support. The binder or (co)polymer may be selected from a polyester resin, a polyamide resin, an epoxy resin, an acrylic resin, a methacrylic resin, a styrene based resin, a polyurethane resin and/or a polyurea resin.

The binder or (co)polymer preferably has one or more functional groups. The functional group(s) can be selected from the list of

(I) a sulfonamide group such as —NR—SO2-, —SO2-NR— or —SO2-NR′R″ wherein R and R′ independently represent hydrogen or an optionally substituted hydrocarbon group such as an optionally substituted alkyl, aryl or heteroaryl group; more details concerning these polymers can be found in EP 2 159 049;

(II) a sulfonamide group including an acid hydrogen atom such as —SO2-NH—CO— or —SO2-NH—SO2- as for example disclosed in U.S. Pat. No. 6,573,022 and/or EP 909 68(of 5)7; suitable examples of these compounds include for example N-(p-toluenesulfonyl) methacrylamide and N-(p-toluenesulfonyl) acrylamide;

(III) an urea group such as —NH—CO—NH—, more details concerning these polymers can be found in WO 01/96119;
(IV) a star polymer in which at least three polymer chains are bonded to a core as described in EP 2 497 639;
(V) a carboxylic acid group;
(VI) a nitrile group;
(VII) a sulfonic acid group;
(VIII) a phosphoric acid group and/or
(IX) a urethane group.

(Co)polymers including a sulfonamide group are preferred. Sulfonamide (co)polymers are preferably high molecular weight compounds prepared by homopolymerization of monomers containing at least one sulfonamide group or by copolymerization of such monomers and other polymerizable monomers. Preferably, in the embodiment where the poly(vinyl acetate) binder is present in the first layer, the copolymer comprising at least one sulfonamide group is present in the second layer located between the layer including the poly(vinyl acetal) binder of the present invention and the hydrophilic support.

Examples of monomers copolymerized with the monomers containing at least one sulfonamide group include monomers as disclosed in EP 1 262 318, EP 1 275 498, EP 909 657, EP 1 120 246, EP 894 622, U.S. Pat. No. 5,141,838, EP 1 545 878 and EP 1 400 351. Monomers such as alkyl or aryl (meth)acrylate such as methyl (meth)acrylate, ethyl (meth)acrylate, butyl (meth)acrylate, benzyl (meth)acrylate, 2-phenylethyl (meth)acrylate, hydroxylethyl (meth)acrylate, phenyl (meth)acrylate; (meth)acrylic acid; (meth)acrylamide; a N-alkyl or N-aryl (meth)acrylamide such as N-methyl (meth)acrylamide, N-ethyl (meth)acrylamide, N-phenyl (meth)acrylamide, N-benzyl (meth)acrylamide, N-methylol (meth)acrylamide, N-(4-hydroxyphenyl)(meth)acrylamide, N-(4-methylpyridyl)(meth)acrylate; (meth)acrylonitrile; styrene; a substituted styrene such as 2-, 3- or 4-hydroxy-styrene, 4-benzoic acid-styrene; a vinylpyridine such as 2-vinylpyridine, 3-vinylpyridine, 4-vinylpyridine; a substituted vinylpyridine such as 4-methyl-2-vinylpyridine; vinyl acetate, optionally the copolymerised vinyl acetate monomeric units are at least partially hydrolysed, forming an alcohol group, and/or at least partially reacted by an aldehyde compound such as formaldehyde or butyraldehyde, forming an acetal or butyral group; vinyl alcohol; vinyl acetal; vinyl butyral; a vinyl ether such as methyl vinyl ether; vinyl amide; a N-alkyl vinyl amide such as N-methyl vinyl amide, caprolactame, vinyl pyrrolydone; maleimide; a N-alkyl or N-aryl maleimide such as N-benzyl maleimide, are preferred.

Suitable examples of sulfonamide (co)polymers and/or their method of preparation are disclosed in EP 933 682, EP 982 123, EP 1 072 432, WO 99/63407, EP 1 400 351 and EP 2 159 049. A highly preferred example of a sulfonamide (co)polymer is described in EP 2 047 988 A in [0044] to [0046].

Specific preferred examples of sulphonamide (co)polymers are polymers comprising N-(p-aminosulfonylphenyl) (meth)acrylamide, N-(m-aminosulfonylphenyl) (meth)acrylamide N-(o-aminosulfonylphenyl) (meth)acrylamide and or m-aminosulfonylphenyl (meth)acrylate.

(Co)polymers including an imide group are also preferred as a binder in the heat-sensitive coating. Specific examples include derivatives of methyl vinyl ether/maleic anhydride copolymers and derivatives of styrene/maleic anhydride copolymers, that contain an N-substituted cyclic imide monomeric units and/or N-substituted maleimides such as a N-phenylmaleimide monomeric unit and a N-benzyl-maleimide monomeric unit. This copolymer is preferably alkali soluble. Suitable examples are described in EP 933 682, EP 894 622 A [0010] to [0033], EP 901 902, EP 0 982 123 A [007] to [0114], EP 1 072 432 A [0024] to [0043] and WO 99/63407 (page 4 line 13 to page 9 line 37).

Polycondensates and polymers having free phenolic hydroxyl groups, as obtained, for example, by reacting phenol, resorcinol, a cresol, a xylenol or a trimethylphenol with aldehydes, especially formaldehyde, or ketones, may also be added to the heat-sensitive coating. Condensates of sulfamoyl- or carbamoyl-substituted aromatics and aldehydes or ketones are also suitable. Polymers of bismethylol-substituted ureas, vinyl ethers, vinyl alcohols, vinyl acetals or vinylamides and polymers of phenylacrylates and copolymers of hydroxy-phenylmaleimides are likewise suitable. Furthermore, polymers having units of vinylaromatics or aryl (meth)acrylates may be mentioned, it being possible for each of these units also to have one or more carboxyl groups, phenolic hydroxyl groups, sulfamoyl groups or carbamoyl groups. Specific examples include polymers having units of 2-hydroxyphenyl (meth)acrylate, of 4-hydroxystyrene or of hydroxyphenylmaleimide. The polymers may additionally contain units of other monomers which have no acidic units. Such units include vinylaromatics, methyl (meth)acrylate, phenyl(meth)acrylate, benzyl (meth)acrylate, methacrylamide or acrylonitrile.

The dissolution behavior of the coating can be fine-tuned by optional solubility regulating components. More particularly, developability enhancing compounds, development accelerators and development inhibitors can be used. In the embodiment where the coating comprises more than one layer, these ingredients can be added to the first layer and/or to the second layer and/or to an optional other layer of the coating.

Suitable developability enhancing compounds are (i) compounds which upon heating release gas as disclosed in WO 2003/79113, (ii) the compounds as disclosed in WO 2004/81662, (iii) the compositions that comprises one or more basic nitrogen-containing organic compounds as disclosed in WO 2008/103258 and (iv) the organic compounds having at least one amino group and at least one carboxylic acid group as disclosed in WO 2009/85093.

Examples of basic nitrogen-containing organic compounds useful in the developability-enhancing compositions are N-(2-hydroxyethyl)-2-pyrrolidone, 1-(2-hydroxyethyl)piperazine, N-phenyldiethanolamine, triethanolamine, 2-[bis(2-hydroxyethyl)amino]-2-hydroxymethyl-1.3-propanediol, N,N,N′,N′-tetrakis(2-hydroxyethyl)-ethylenediamine, N,N,N′,N′-tetrakis(2-hydroxypropyl)-ethylenediamine, 3-[(2-hydroxyethyl)phenylamino]propionitrile, and hexahydro-1,3,5-tris(2-hydroxyethyl)-s-triazine. Preferably N, N, N′, N′-tetrakis(2-hydroxypropyl)-ethylenediamine is used. Mixtures of two or more of these compounds are also useful. The basic nitrogen-containing organic compounds can be obtained from a number of commercial sources including BASF (Germany) and Aldrich Chemical Company (Milwaukee, Wis.).

The basic nitrogen-containing organic compound(s) is preferably present in the coating in an amount of from 1 to 30% wt, and typically from 3 to 15% wt, based on the total solids of the coating composition.

Preferably, one or more of the basic nitrogen-containing organic compounds are used in combination with one or more acidic developability-enhancing compounds, such as carboxylic acids or cyclic acid anhydrides, sulfonic acids, sulfinic acids, alkylsulfuric acids, phosphonic acids, phosphinic acids, phosphonic acid esters, phenols, sulfonamides, or sulfonimides, since such a combination may permit further improved developing latitude and printing durability. Representative examples of the acidic developability-enhancing compounds are provided in [0030] to [0036] of US 2005/0214677. They may be present in an amount of from 0.1 to 30% wt based on the total dry weight of the coating composition. The molar ratio of one or more basic nitrogen-containing organic compounds to one or more acidic developability-enhancing compounds is generally from 0.1:1 to 10:1 and more typically from 0.5:1 to 2:1.

Development accelerators are compounds which act as dissolution promoters because they are capable of increasing the dissolution rate of the coating. For example, cyclic acid anhydrides, phenols or organic acids can be used in order to improve the aqueous developability. Examples of the cyclic acid anhydride include phthalic anhydride, tetrahydrophthalic anhydride, hexahydrophthalic anhydride, 3,6-endoxy-4-tetrahydro-phthalic anhydride, tetrachlorophthalic anhydride, maleic anhydride, chloromaleic anhydride, alpha-phenylmaleic anhydride, succinic anhydride, and pyromellitic anhydride, as described in U.S. Pat. No. 4,115,128. Examples of the phenols include bisphenol A, p-nitrophenol, p-ethoxyphenol, 2,4,4′-trihydroxybenzophenone, 2,3,4-trihydroxy-benzophenone, 4-hydroxybenzophenone, 4,4′,4″-trihydroxy-triphenylmethane, and 4,4′,3″,4″-tetrahydroxy-3,5,3′,5′-tetramethyltriphenyl-methane, and the like. Examples of the organic acids include sulphonic acids, sulfinic acids, alkylsulfuric acids, phosphonic acids, phosphates, and carboxylic acids, as described in, for example, JP-A Nos. 60-88,942 and 2-96,755. Specific examples of these organic acids include p-toluenesulphonic acid, dodecylbenzenesulphonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, 3,4,5-trimethoxybenzoic acid, 3,4,5-trimethoxycinnamic acid, phthalic acid, terephthalic acid, 4-cyclohexene-1,2-dicarboxylic acid, erucic acid, lauric acid, n-undecanoic acid, and ascorbic acid. The amount of the cyclic acid anhydride, phenol, or organic acid contained in the coating is preferably in the range of 0.05 to 20% by weight, relative to the coating as a whole. Polymeric development accelerators such as phenolic-formaldehyde resins comprising at least 70 mol % meta-cresol as recurring monomeric units are also suitable development accelerators.

In a preferred embodiment, the coating also contains developer resistance means, also called development inhibitors, i.e. one or more ingredients which are capable of delaying the dissolution of the unexposed areas during processing. The dissolution inhibiting effect is preferably reversed by heating, so that the dissolution of the exposed areas is not substantially delayed and a large dissolution differential between exposed and unexposed areas can thereby be obtained. The compounds described in e.g. EP 823 327 and WO 97/39894 act as dissolution inhibitors due to interaction, e.g. by hydrogen bridge formation, with the alkali-soluble resin(s) in the coating. Inhibitors of this type typically are organic compounds which include at least one aromatic group and a hydrogen bonding site such as a nitrogen atom which may be part of a heterocyclic ring or an amino substituent, an onium group, a carbonyl, sulfinyl or sulfonyl group. Suitable dissolution inhibitors of this type have been disclosed in e.g. EP 825 927 and EP 823 327. Some of the compounds mentioned below, e.g. infrared dyes, such as cyanines, and contrast dyes, such as quaternized triarylmethane dyes, can also act as a dissolution inhibitor.

Other suitable inhibitors improve the developer resistance because they delay the penetration of the aqueous alkaline developer into the coating. Such compounds can be present in the first layer and/or in the optional second layer and/or in a development barrier layer on top of said layer, as described in e.g. EP 864 420, EP 950 517, WO 99/21725 and WO 01/45958. The solubility and/or penetrability of the barrier layer in the developer can be increased by exposure to heat and/or infrared light.

Water-repellent polymers represent another type of suitable dissolution inhibitors. Such polymers seem to increase the developer resistance of the coating by repelling the aqueous developer from the coating. In the embodiment where the coating comprises more than one layer, the water-repellent polymers can be added to the first layer and/or to the second layer and/or in a separate layer provided on top of these layers. In the latter embodiment, the water-repellent polymer forms a barrier layer which shields the coating from the developer and the solubility of the barrier layer in the developer or the penetrability of the barrier layer by the developer can be increased by exposure to heat or infrared light, as described in e.g. EP 864 420, EP 950 517 and WO99/21725.

Preferred examples of inhibitors which delay the penetration of the aqueous alkaline developer into the coating include water-repellent polymers including siloxane and/or perfluoroalkyl units. The polysiloxane may be a linear, cyclic or complex cross-linked polymer or copolymer. The term polysiloxane compound shall include any compound which contains more than one siloxane group —Si(R,R)—O—, wherein R and R′ are optionally substituted alkyl or aryl groups. Preferred siloxanes are phenylalkylsiloxanes and dialkylsiloxanes. The number of siloxane groups in the polymer is at least 2, preferably at least 10, more preferably at least 20. It may be less than 100, preferably less than 60.

The water-repellent polymer may be a block-copolymer or a graft-copolymer including a polar block such as a poly- or oligo(alkylene oxide) and a hydrophobic block such as a long chain hydrocarbon group, a polysiloxane and/or a perfluorinated hydrocarbon group. A typical example of a perfluorinated surfactant is Megafac F-177 available from Dainippon Ink & Chemicals, Inc. Other suitable copolymers comprise about 15 to 25 siloxane units and 50 to 70 alkyleneoxide groups. Preferred examples include copolymers comprising phenylmethylsiloxane and/or dimethylsiloxane as well as ethylene oxide and/or propylene oxide, such as Tego Glide 410, Tego Wet 265, Tego Protect 5001 or Silikophen P50/X, all commercially available from Tego Chemie, Essen, Germany.

A suitable amount of such a water-repellent polymer in the coating is between 0.5 and 25 mg/m², preferably between 0.5 and 15 mg/m² and most preferably between 0.5 and 10 mg/m². When the water-repellent polymer is also ink-repelling, e.g. in the case of polysiloxanes, higher amounts than 25 mg/m² can result in poor ink-acceptance of the non-exposed areas. An amount lower than 0.5 mg/m² on the other hand may lead to an unsatisfactory development resistance.

It is believed that during coating and drying, the water-repellent polymer or copolymer acts as a surfactant and tends to position itself, due to its bifunctional structure, at the interface between the coating and air and thereby forms a separate top layer, even when applied as an ingredient of the coating solution. Simultaneously, such surfactants also act as spreading agents which improve the coating quality. Alternatively, the water-repellent polymer or copolymer can be applied in a separate solution, coated on top of the coating including one or optional more layers. In that embodiment, it may be advantageous to use a solvent in the separate solution that is not capable of dissolving the ingredients present in the other layers so that a highly concentrated water-repellent phase is obtained at the top of the coating.

The coating of the heat-sensitive printing plate precursors described above preferably also contains an infrared light absorbing dye or pigment which, in the embodiment where the coating comprises more than one layer, may be present in the first layer, and/or in the second layer, and/or in an optional other layer. Preferred IR absorbing dyes are cyanine dyes, merocyanine dyes, indoaniline dyes, oxonol dyes, pyrilium dyes and squarilium dyes. Examples of suitable IR dyes are described in e.g. EP-As 823327, 978376, 1029667, 1053868, 1093934; WO 97/39894 and 00/29214. A preferred compound is the following cyanine dye:

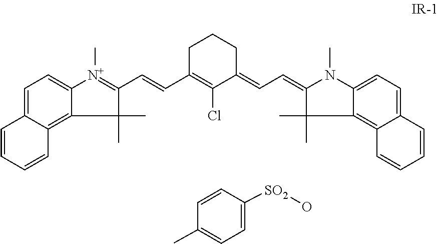

The concentration of the IR-dye in the coating is preferably between 0.25 and 15.0% wt, more preferably between 0.5 and 10.0% wt, most preferably between 1.0 and 7.5% wt relative to the coating as a whole.

The coating may further comprise one or more colorant(s) such as dyes or pigments which provide a visible color to the coating and which remain in the coating at the image areas which are not removed during the processing step. Thereby a visible image is formed and examination of the lithographic image on the developed printing plate becomes feasible. Such dyes are often called contrast dyes or indicator dyes. Preferably, the dye has a blue color and an absorption maximum in the wavelength range between 600 nm and 750 nm. Typical examples of such contrast dyes are the amino-substituted tri- or diarylmethane dyes, e.g. crystal violet, methyl violet, victoria pure blue, flexoblau 630, basonylblau 640, auramine and malachite green. Also the dyes which are discussed in depth in EP-A 400,706 are suitable contrast dyes. Dyes which, combined with specific additives, only slightly color the coating but which become intensively colored after exposure, as described in for example WO2006/005688 may also be used as colorants.

Optionally, the coating may further contain additional ingredients such as surfactants, especially perfluoro surfactants, silicon or titanium dioxide particles, organic or inorganic spacer particles or matting agents.

Any coating method can be used for applying one or more coating solutions to the hydrophilic surface of the support. The multi-layer coating can be applied by coating/drying each layer consecutively or by the simultaneous coating of several coating solutions at once. In the drying step, the volatile solvents are removed from the coating until the coating is self-supporting and dry to the touch. However it is not necessary (and may not even be possible) to remove all the solvent in the drying step. Indeed the residual solvent content may be regarded as an additional composition variable by means of which the composition may be optimized. Drying is typically carried out by blowing hot air onto the coating, typically at a temperature of at least 70° C., suitably 80-150° C. and especially 90-140° C. Also infrared lamps can be used. The drying time may typically be 15-600 seconds.

Between coating and drying, or after the drying step, a heat treatment and subsequent cooling may provide additional benefits, as described in WO99/21715, EP-A 1074386, EP-A 1074889, WO00/29214, and WO/04030923, WO/04030924, WO/04030925.

### Exposure

The printing plate precursor can be exposed to infrared light by means of e.g. LEDs or a laser. Most preferably, the light used for the exposure is a laser emitting near infrared light having a wavelength in the range from about 750 to about 1500 nm, more preferably 750 to 1100 nm, such as a semiconductor laser diode, a Nd:YAG or a Nd:YLF laser. The required laser power depends on the sensitivity of the plate precursor, the pixel dwell time of the laser beam, which is determined by the spot diameter (typical value of modern plate-setters at 1/e² of maximum intensity: 5-25 μm), the scan speed and the resolution of the exposure apparatus (i.e. the number of addressable pixels per unit of linear distance, often expressed in dots per inch or dpi; typical value: 1000-4000 dpi).

The printing plate thus obtained can be used for conventional, so-called wet offset printing, in which ink and an aqueous dampening liquid is supplied to the plate. Another suitable printing method uses a so-called single-fluid ink without a dampening liquid. Suitable single-fluid inks have been described in U.S. Pat. Nos. 4,045,232; 4,981,517 and 6,140,392. In a most preferred embodiment, the single-fluid ink comprises an ink phase, also called the hydrophobic or oleophilic phase, and a polyol phase as described in WO 00/32705.

### EXAMPLES

All materials used in the following examples were readily available from standard sources such as Sigma-Aldrich (Belgium) and Acros (Belgium) unless otherwise specified.

The pKa of the (co)polymer in the second layer of the Energy Elite Eco plate precursor, commercially available from AGFA NV, has a pKa of 7.37 at 25° C. (S. I. Kang, Y. H. Bae, Journal of controlled release, 2002, 80, 145).

### Preparation of the Gum Solutions

TABLE 1
Composition of the Gum solutions Gum-01 to Gum-05

| INGREDIENTS | Gum-01 | Gum-02 | Gum-03 | Gum-04 | Gum-05 |
|---|---|---|---|---|---|
| Demineralized water | 250 | 250 | 250 | 400 | 400 |
| mL | | | | | |
| CALFAX 10L-45 | 400 | 400 | 400 | 300 | 400 |
| mL(1) | | | | | |
| Citric acid | 118.8 | 35.6 | 118.8 | 23.7 | 32 |
| monohydrate g | | | | | |
| Potassium citrate | — | — | — | — | 74 |
| monohydrate g | | | | | |
| KOH 50% | 48.3 | 14 | 149.9 | 9.66 | — |
| g | | | | | |
| Promex BM K5050A | 10.3 | 10.3 | 10.3 | 10.3 | 10.3 |
| g (2) | | | | | |
| SE57 | 1 | 1 | 1 | 1 | 1 |
| mL (3) | | | | | |
| Sodium | 150 | 150 | 150 | 150 | 150 |
| hexametaphosphate | | | | | |
| g | | | | | |
| Complete with | 1000 | 1000 | 1000 | 1000 | 1000 |
| Demineralized water | | | | | |
| to mL | | | | | |

(1)CALFAX 10L-45 is a solution of solution of mono- and di-alkyl disulphonated diphenyloxide, disodium salt commercially available from Pilot Chemical Company;
(2) Promex BM K5050A is a biocid commercially available from Vink Chemicals;
(3) SE57 is an antifoam commercially available from Wacker Chemie;

### Plate Sensitivity

An Energy Elite Eco plate precursor was exposed at different energy densities on a Avalon N8-90 XT, commercially available from AGFA NV. Directly after exposure the plate was inserted in an Arkana processor 125, commercially available from AGFA NV, operating at 150 cm/min and at a temperature of 25° C., filled with Arkana Developer and Arkana Gum, both commercially available from Agfa NV, and operating with Arkana Replenisher, commercially available from AGFA NV.

The plate sensitivity of the processed plate was determined and defined as the energy density at which the 4×4 pixel checkerboard pattern has a 46% dot area coverage as measured with a Techkon SpectroPlate, commercially available from Techkon Gmbh.

### Exhaustion Test

A set of Energy Elite Eco plate precursors were fully exposed at the plate sensitivity on an Avalon N8-90 XT operating at 210 rpm.

X m² of fully exposed plates, at a frequency of 200 m² per day, were inserted in an Arkana processor 125 operating at 150 cm/min and at a temperature of 25° C., filled with Arkana Developer and operating with Arkana Replenisher.

The pH of the gumming units was measured at start and after x m² of processing, using a Profiline pH/Cond 3320 commercially available from WTW.

The contamination of the first gumming unit was evaluated, visually, after draining the Gum Solutions exhausted with x m² of plates, 48 h after the last processed plate. A score between 0 and 5 was given depending on the sludge amount observed. A score of 0 was given when no sludge could be observed and a score of 5 was given when an excessive amount of sludge could be observed. Sludge samples were then taken for analysis.

TABLE 2
Exhaustion test

| | | pH in first | | pH in second | | |
|---|---|---|---|---|---|---|
| | | gumming unit | | gumming unit | | Contamination in |
| Gum | | pH at | pH at | pH at | pH at | first gumming |
| Solution | x m² | 0 m² | x m² | 0 m² | x m² | unit after x m²* |
| Gum-01 | 1000 | 3.2 | 4.5 | 3.2 | 3.5 | 4 |
| Gum-02 | 830 | 4.2 | 6.7 | 4.2 | 4.7 | 3 |
| Gum-03 | 750 | 5.4 | 7.2 | 5.4 | 5.9 | 3 |
| Gum-04 | 1250 | 4.1 | 9.1 | 4.1 | 4.8 | 1 |
| Gum-05 | 4000 | 4.8 | 7.9 | 4.8 | 5.3 | 1 |

*Sludge formation visually scored after draining the gum solution as follows:
0 = no sludge
1 = substantially no sludge
2 = minor amount of sludge
3 = major amount of sludge
4 = huge amount of sludge
5 = excessive amount of sludge.

### Results

Analysis of the sludge samples show that in all the cases the sludge is mainly composed of the (co)polymer in the second layer of the printing plate and CALFAX 10L-45.

The results in Table 2 show that when the pH in the first gumming unit increases above the pKa of the (co)polymer in the second layer, i.e. Gum-04 and Gum 05, the sludge amount observed in the first gumming unit is significantly reduced.

### Print Quality

Energy Elite Eco plate precursors were processed at the end of each of the exhaustion test and subsequently subjected to an accelerated ageing test in a controlled environment of 85% relative humidity and 20° C. for a time period of 4 days. The print quality was visually assessed for print artefacts on sheets printed on a GTO 52 Dg printing machine, commercially available from Heidelberg.

TABLE 3
Print quality test

| | | Print quality | |
|---|---|---|---|
| Gum Solution | x m² | at 0 m² | at x m² |
| Gum-01 | 1000 | Good | Good |
| Gum-02 | 830 | Good | Good |
| Gum-03 | 750 | Good | Spots in non- |
| | | | image area |
| Gum-04 | 1250 | Good | Good |
| Gum-05 | 4000 | Good | Good |

The results in Table 3 show that when the pH in the second gumming unit is too high, i.e. above 5.5, the print quality is impaired.

### Gum Titration

The pH of the first and second gumming units are changing during plate processing due to cross-contamination between the developing solution and the first gumming unit, also called flow-over or carry over, and due to cross-contamination between the first and the second gumming unit.

The pH evolution of the gumming units due to cross-contamination were simulated by titration.

In a first titration test, to simulate the cross-contamination of the first gumming unit, 26 mL of Arkana Developer was respectively added stepwise (per 2 mL) to 50 ml of the beforehand diluted gum solutions Gum-01 and Gum-05. The gum solutions were diluted using one part of gum and 4 parts of dimeniralised water.

In a second titration test, to simulate the cross-contamination of the second gumming unit, 50 mL of a mixture (MIX-01) prepared with 50 mL of diluted gum and 12 mL of Arkana developer was respectively added stepwise (per 5 mL) to 50 mL of the diluted gum solutions Gum-01 and Gum-05. The gum solutions were diluted using one part of gum and 4 parts of dimeniralised water.

The evolution of the pH upon titration of the gum solutions are summarized in Table 4 and Table 5.

TABLE 4
Cross-contamination simulation
of the first gumming unit

| Arkana developer | Diluted Gum-01 | Diluted Gum-05 |
|---|---|---|
| addition | Comparative | Inventive |
| mL | pH | pH |
| 2 | 3.9 | 5.2 |
| 4 | 4.1 | 5.5 |
| 6 | 4.4 | 5.9 |
| 8 | 4.7 | 6.2 |
| 10 | 4.9 | 6.6 |
| 12 | 5.1 | 7.3 |
| 14 | 5.4 | 11.5 |
| 16 | 5.5 | 12.1 |
| 18 | 5.7 | 12.4 |
| 20 | 5.9 | 12.5 |
| 22 | 6.1 | 12.6 |
| 24 | 6.3 | 12.7 |
| 26 | 6.4 | 12.7 |

TABLE 5
Cross-contamination simulation
of the second gumming unit

| MIX-01 | Diluted Gum-01 | Diluted Gum-05 |
|---|---|---|
| addition | comparative | inventive |
| mL | pH | pH |
| 5 | 3.7 | 5.1 |
| 10 | 3.8 | 5.2 |
| 15 | 3.9 | 5.3 |
| 20 | 4 | 5.4 |
| 25 | 4 | 5.5 |
| 30 | 4.1 | 5.6 |
| 35 | 4.1 | 5.6 |
| 40 | 4.2 | 5.7 |
| 50 | 4.3 | 5.8 |

The results in Table 4 and FIG. 1 (FIG. 1, dashed line) show that the buffer capacity of the diluted GUM-01 is too strong to allow a pH increase above the pKa of the (co)polymer of the second layer of the Energy Elite Eco plate precursor, in the first gumming unit. The results in Table 4 and FIG. 1 (FIG. 1, solid line) further show that the diluted GUM-05 allows a pH increase above the pKa of the (co)polymer of the second layer of the Energy Elite Eco plate precursor.

The results in Table 5 and FIG. 2 show that, in the second gumming unit, the diluted GUM-05 which allows a pH increase above the pKa of the (co)polymer of the second layer of the Energy Elite Eco plate precursor during processing (FIG. 2, solid line), can maintain a similar pH stability as diluted GUM-01 (FIG. 2, dashed line).

1-15. (canceled)

16. A method for processing a heat-sensitive positive-working lithographic printing plate material which comprises on a support having a hydrophilic surface or which is provided with a hydrophilic layer, a heat and/or light-sensitive coating which comprises at least two layers:
a first layer comprising an oleophilic resin and/or a vinyl acetal (co)polymer and
a second layer comprising a (co)polymer which is located between the support and the first layer;
the method comprising:
treating the plate material with an alkaline development solution,
treating the plate material with a first gum solution and consecutively with a second gum solution which are configured as a cascade whereby the second gum solution overflows into the first gum solution and which gum solutions include a buffer;
characterized in that the pH of the first gum solution reaches a steady state value above the pKa value of the (co)polymer present in the second layer.

17. The method of claim 16, wherein the buffer has a capacity which allows a pH change of the first gum solution.

18. The method of claim 16, wherein the buffer has a capacity which maintains the pH of the second gum solution substantially constant.

19. The method of claim 16, wherein the steady state value of the pH of the first gum solution is at least two units above its initial pH.

20. The method of claim 16, wherein the steady state value of the pH of the first gum solution is at least three units above its initial pH.

21. The method of claim 16, wherein the buffer maintains the pH of the second gum solution to a value between 0.5 and 7.

22. The method of claim 16, wherein the buffer maintains the pH of the second gum solution to a value between 0.5 and 6.

23. The method of claim 16, wherein the second layer comprises a (co)polymer including at least one sulfonamide group, an imide group, a nitrile group, a urethane group, a urea group, a carboxyl group, a sulfonic acid group, and/or a phosphoric acid group.

24. The method of claim 23, wherein the second layer comprises a (co)polymer including at least one sulfonamide group.

25. The method of claim 16, wherein the buffer is a mixture containing at least one acid having a pKa between 2 and 6, and its metal salt.

26. The method of claim 16, wherein the buffer is a mixture containing at least one acid having a pKa between 3 and 5, and its metal salt.

27. The method of claim 16, wherein the gum solution has an initial pH between 0.5 and 6.

28. The method of claim 16, wherein the pH of the second gum solution is lower than the steady state pH of the first gum solution.

29. The method of claim 16, wherein the steady state value is reached after processing at least 400 m² plate material.

30. The method of claim 16, wherein the steady state value is reached after processing at least 1000 m² plate material.
